(19) United States
(12) Patent Application Publication
(10) Pub. No.: US 2023/0414457 A1
(43) Pub. Date: Dec. 28, 2023

(54) SUPPLEMENTARY NURSING SYSTEM (SNS) PUMP AND NIPPLE SHIELD WITH GECKO-ADHESION AND SNS CONDUCTION SYSTEM

(71) Applicant: University of Florida Research Foundation, Incorporated, Gainesville, FL (US)

(72) Inventors: Ge QU, Gainesville, FL (US); Bruce D. SPIESS, Gainesville, FL (US)

(21) Appl. No.: 18/253,616

(22) PCT Filed: Nov. 22, 2021
(86) PCT No.: PCT/US2021/060257

§ 371 Date: May 19, 2023

Related U.S. Application Data
(60) Provisional application No. 63/117,026, filed on Nov. 23, 2020.

(51) Int. Cl. A61J 13/00; A61J 11/00

(52) U.S. Cl. CPC A61J 13/00; A61J 11/0005

(57) ABSTRACT

System, devices, and methods relating to breastfeeding assistance systems, nipple shields, supplemental nursing systems, and use thereof are described herein. Various embodiments provide a nipple shield to be placed on a breast and cover a nipple of a nursing woman. In various embodiments, the nipple shield comprises micro-structures configured to adhere to a breast. In various embodiments, the micro-structures comprise angled fibers. In various embodiments, the nipple shield comprises a Supplementary Nursing System (SNS) conduction system configured to fluidly connect an SNS to the nipple shield. In various embodiments, the SNS conduction system comprises a port and microtubes.

### CROSS-REFERENCE TO RELATED APPLICATIONS

This application claims priority to U.S. application Ser. No. 63/117,026, filed Nov. 23, 2020, the content of which is hereby incorporated by reference herein in its entirety.

### FIELD OF THE INVENTION

Various embodiments relate to a breastfeeding assistance system comprising a nipple shield and/or a supplemental nursing system (SNS).

### BACKGROUND

Nursing women often experience various difficulties while nursing, including infant latch-on difficulties and discomfort. Nipple shields are often used to combat these difficulties by providing a large and firm target for latching and protection of the nipple. However, conventional nipple shields have poor surface attachment and thus often slip down or fall off the woman's breast with the weight of gravity.

In various scenarios, a nursing woman may use a supplementary nursing system (SNS) to provide supplementary nutrition to the infant. However, conventional nipple shields are not compatible with a Supplementary Nursing System (SNS).

Conventionally, SNS are configured to conduct fluid, such as breast milk or formula, through a small tube that is taped to a nursing woman's nipple such that the fluid is provided to the nursing infant via the tube. Generally, an SNS consists of a bottle hung around the woman's neck and a microtube for the fluid to drain down from the bottle to the nursing infant's mouth. However, as such systems are gravity operated, the fluid flow is not adjustable to the baby's suction motion, which reduces the functionality of the SNS helping to train the nursing infant on effective nursing technique and can lead to a significant amount of spilled fluid.

### BRIEF SUMMARY

System, devices, and methods relating to nipple shields and use thereof are described herein. Various embodiments provide a nipple shield to be placed on a breast and cover a nipple of a nursing woman. In various embodiments, the nipple shield comprises micro-structures configured to adhere to the breast. In various embodiments, the micro-structures generally cover at least a portion of the inner surface of the nipple shield. In various embodiments, the micro-structures comprise angled fibers.

In various embodiments, the nipple shield comprises a Supplementary Nursing System (SNS) conduction system configured to fluidly connect an SNS to the nipple shield. In various embodiments, the SNS conduction system comprises microtubes disposed between the inner surface and the outer surface of the nipple shield and a port configured for coupling the SNS conduction system to the nipple shield. In various embodiments, the nipple shield comprises micro-structures configured to adhere to the breast and an SNS conduction system configured to fluidly connect an SNS system to the nipple shield.

System, devices, and methods relating to SNSs and use thereof are described herein. Various embodiments provide a SNS system comprising an SNS pump that includes an elastomeric reservoir configured to store fluid for dispensing and a flow adjusting valve configured to control the flow of fluid being dispensed from the elastomeric reservoir. Various embodiments of the SNS pump may be used independently (e.g., without a nipple shield) or with a nipple shield.

According to a first aspect, a breastfeeding assistance system is provided. In an example embodiment, the breastfeed assistance system comprises a nipple shield; and an SNS pump. The nipple shield comprises (1) a base having (a) an inner surface, and (b) an outer surface, and (2) an SNS conduction system. The SNS conduction system comprises one or more (e.g., two) shield coupling elements and one or more microtubes. Each of the shield coupling elements is configured to fluidly couple a dispensing assembly of an SNS system (e.g., the SNS pump) to the microtubes. The microtubes are disposed between the inner surface and outer surface of the nipple shield. At least one of the microtubes is fluidly coupled to the coupling element and extends from the coupling element to an outlet. The SNS pump comprises an elastomeric reservoir configured to received fluid therein; and a dispensing assembly configured fluidly couple the elastomeric reservoir to a dispensing end. The dispensing assembly comprises a tube extending from the elastomeric reservoir to the dispensing end and a fluid control valve configured to control the flow of fluid through the tube. The dispensing end is configured to be fluidly coupled to the shield coupling element.

According to another aspect, a nipple shield that is configured to adhere to a breast and allow for nursing of an infant is provided. In an example embodiment, the nipple shield comprises an inner surface; an outer surface; and a base. The inner surface comprises micro-structures configured to adhere to a breast.

According to another aspect, a nipple shield configured for use with an SNS is provided. In an example embodiment, the nipple shield comprises (1) a base having (a) an inner surface, and (b) an outer surface, and (2) a supplementary nursing system (SNS) conduction system. The SNS conduction system comprising one or more (e.g., two) coupling elements and one or more microtubes. Each of the one or more coupling elements is configured to fluidly couple a dispensing assembly of an SNS to the microtubes. The microtubes are disposed between the inner surface and outer surface. At least one of the microtubes is fluidly coupled to the coupling element and extends from the coupling element to an outlet.

According to still another aspect, an SNS pump is provided. In various embodiments, the SNS pump comprises an elastomeric reservoir configured to received fluid therein and to apply a compressive force on the fluid received therein; and a dispensing assembly configured fluidly couple the elastomeric reservoir to a dispensing end. The dispensing assembly comprises a tube extending from the elastomeric reservoir to the dispensing end and a fluid control valve configured to control the flow of fluid through the tube.

### BRIEF DESCRIPTION OF THE DRAWINGS

Having thus described various embodiments in general terms, reference will now be made to the accompanying drawings, which are not necessarily drawn to scale, and wherein:

FIG. 1 is a perspective view of the nipple shield according to one embodiment with micro-structures, according to an example embodiment.

FIG. 2 is a top view of the nipple shield of FIG. 1, according to an example embodiment.

FIG. 3 is a profile view of the nipple shield according to one embodiment with micro-structures and an SNS conduction system, comprising two coupling elements, according to an example embodiment.

FIG. 4 is a close-up view of micro-structures, according to an example embodiment.

FIG. 5 is a diagram of the multi-membrane port of the SNS conduction system, according to an example embodiment.

FIG. 6 is a diagram of the pairing port of the SNS conduction system, according to an example embodiment.

FIG. 7 is perspective view of an example embodiment of an SNS pump that may be used independently or with a nipple shield, in various embodiments.

FIG. 8 provides a flowchart illustrating a various processes of an example method of use for the nipple shield, according to an example embodiment.

FIG. 9 provides a flowchart illustrating a various processes of an example method of use for the SNS pump, according to an example embodiment.

### DETAILED DESCRIPTION

Various embodiments of the present disclosure now will be described more fully hereinafter with reference to the accompanying drawings, in which some, but not all embodiments of the disclosure are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

As used in this specification, the singular forms “a,” “an” and “the” include plural referents unless the context clearly dictates otherwise. Thus, for example, the term “a region” is intended to mean a single region or a combination of regions.

Various embodiments provide a breastfeeding assistance system comprising a nipple shield and/or an SNS pump. In various embodiments, the nipple shield may be used independently and/or with the SNS pump. In various embodiments, the SNS pump may be used independent and/or with the nipple shield.

### Example Nipple Shield

Described herein are various embodiments for a nipple shield configured to be attached to a breast and cover a nipple of a nursing woman. The nipple shield, sometimes referred to as a nipple guard, is intended to be used by a nursing woman to aid in infant latch-on and/or provide a Supplementary Nursing System (SNS) conduction system. For example, the nipple shield described herein may be used in various circumstances such as assisting in situations with latch-on difficulties due to premature infants; tongue-tied infants; and/or retracted, flat, or inverted nipples.

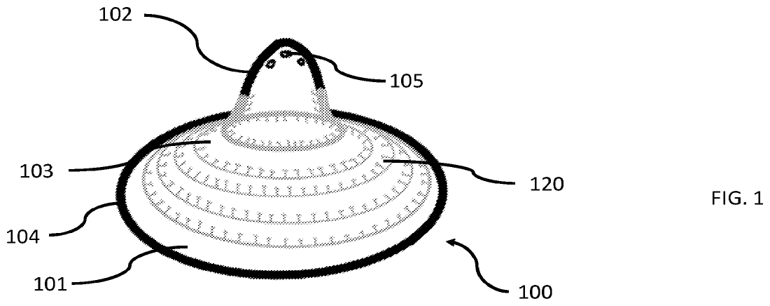

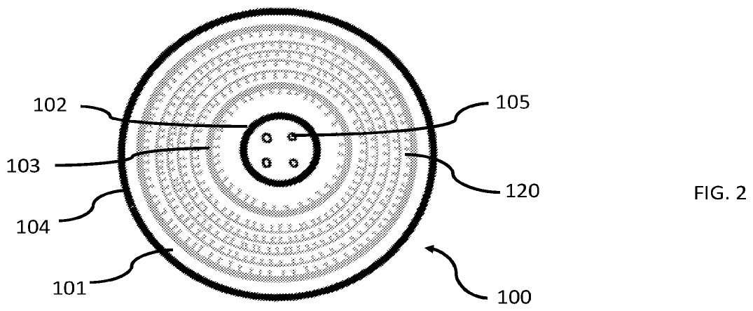

FIGS. 1-3 illustrate a nipple shield 100 according to various embodiments. The nipple shield 100 is configured to receive a nipple of a nursing woman. As shown in the illustrated embodiments, the nipple shield 100 comprises a base 101 and a nipple portion 102. Further shown in the illustrated embodiments, the nipple shield 100 comprises an inner surface 106 and an outer surface 107. In various embodiments, the base 101 is dome-shaped and extends from the outer rim 104 of the nipple shield 100 to the inner rim 103 of the nipple shield 100 and the nipple portion 102 extends from the inner rim 103 of the nipple shield 100. In various embodiments, the nipple shield 100 comprises at least one hole 105 on the nipple portion 102 to allow for passage of a fluid. In various embodiments, the nipple shield 100 comprises multiple holes 105 on the nipple portion 102 to allow for passage of a fluid. In various embodiments, the hole 105 is at the tip of the nipple portion 102. In various embodiments, the nipple shield 100 is made of a silicon material. In various embodiments, the outer surface 107 of the nipple shield 100 is smooth to allow for easy latch-on of an infant. In various embodiments, the nipple shield 100 is sized to fit a nursing woman's breast therein such that the nursing woman's nipple is received within the nipple portion 102 of the nipple shield 100. For example, in various embodiments, the base 101 has a diameter in a range of 50 to 100 mm (e.g., 75 mm, in an example embodiment) and the nipple portion 102 has a diameter in a range of 18 to 30 mm (e.g., 24 mm, in an example embodiment).

In various embodiments, the nipple shield 100 comprises micro-structures 120 disposed on the inner surface 107. The micro-structures 120 are configured to adhere to a breast. In various embodiments, the micro-structures 120 are in close contact with the skin of the breast and form a seal. In various embodiments, the micro-structures 120 are configured to retain the breast of a nursing woman within the nipple shield 100 using a weak van der Waals interaction.

In various embodiments, the micro-structures 120 are disposed on the inner surface 107 from the outer rim 104 to the inner rim 103. In various embodiments, the micro-structures are disposed on at least a portion of the inner surface 107 of the nipple portion 102. In an example embodiment, the inner surface 107 of the nipple portion 102 is smooth. In various embodiments, at least a portion of the outer rim 104 does not comprise any micro-structures 120. For example, the at least a portion of the outer rim 104 that does not comprise any micro-structures 120 may enable easy removal of the nipple shield from the nursing woman's breast at the end of a nursing session. In various embodiments, the micro-structures 120 are aligned and positioned radially around the inner surface 107. In various embodiments, the micro-structures 120 are distributed evenly and positioned radially around the inner surface 107.

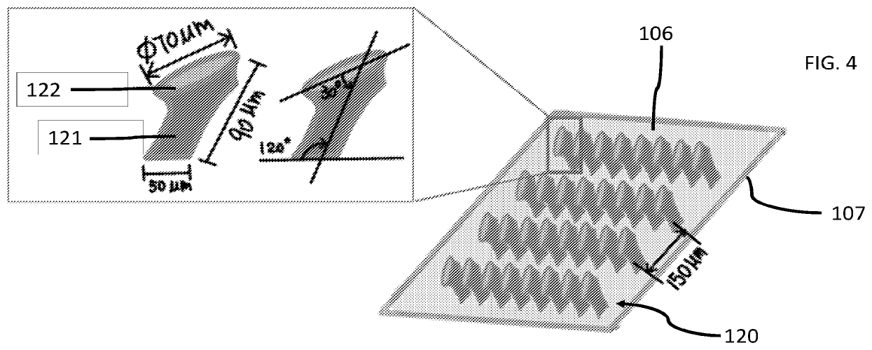

In various embodiments, the micro-structures 120 comprise angled fibers. Angled fibers are chosen for some embodiments because they can exploit weak van der Waals forces and create large overall adhesion. In reference to FIG. 4, in one embodiment, a single micro-structure 120 comprises a micro-scale pillar 121 and an angled mushroom tip 122. A micro-scale pillar 121 and angled mushroom tip 122 allow for directional and controllable adhesion. FIG. 4 indicates the sizes of various components of a micro-structure 120 and/or an array of micro-structures, for one example embodiment. In various embodiments, the micro-structures 120 are directional, allowing, for example, for a nursing woman's nipple to be drawn further into the nipple shield 100 with each suction of an infant.

In various embodiments, micro-scale pillars 121 are evenly distributed on the inner surface 107 in an array. In an example embodiment, the micro-scale pillars 121 are distributes in rings disposed on the inner surface 107 of the base 101. In various embodiments, the distance from one micro-scale pillar 121 in an array to another micro-scale pillar 121 in the array is in a range of approximately 100 to 200 micrometer (μm) (e.g., 150 micrometer μm, in an example embodiment). In various embodiments, the length of a micro-scale pillar 121 is in a range of 60 to 120 μm (e.g., 90 μm, in an example embodiment). In various embodiments, the diameter of a micro-scale pillar 121 is in a range of 20 to 80 μm (e.g., 50 μm, in an example range). In various embodiments, the angle between a micro-scale pillar 121 and the inner surface 107 is in a range of 95 to 145 degrees (e.g., 120 degrees, in an example embodiment) such that the micro-scale pillar 121 is angled toward the tip of the nipple portion 102. In various embodiments, an angled mushroom tip 122 is on top of a micro-scale pillar 121. In various embodiments, the diameter of an angled mushroom tip 122 is in a range of 50 to 90 μm (e.g., 70 μm, in an example embodiment). In various embodiments, the angle between the angled mushroom tip 122 and a micro-scale pillar 121 is in a range of 10 to 50 degrees (e.g., 30 degrees in an example embodiment).

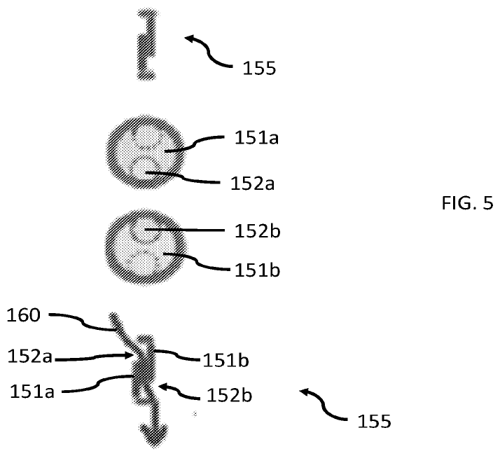

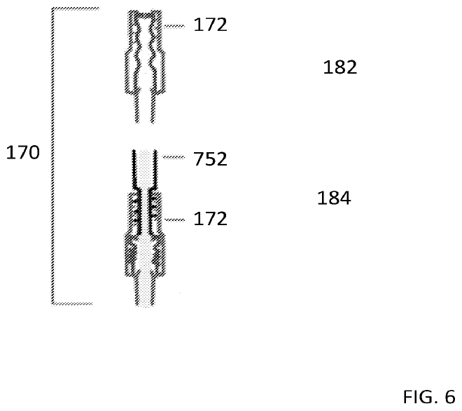

In various embodiments, the nipple shield 100 comprises a Supplementary Nursing System (SNS) conduction system 130. In various embodiments, the SNS conduction system 130 comprises microtubes 140 and one or more coupling elements 150, 170. In the illustrated embodiment, one of the coupling elements 150 comprises is a multi-membrane port 155 (see FIG. 5), such as a double-membrane port. In the illustrated embodiment, one of the coupling elements 170 comprises a pairing port 172 (see FIG. 6). In various embodiments, the microtubes 140 are disposed between the inner surface 106 and the outer surface 107 of the nipple shield 100. In various embodiments, the microtubes 140 are disposed on the inner surface 106 and/or the outer surface 107 of the nipple shield 100. Each of the coupling elements 150, 170 are configured to fluidly couple the SNS conduction system 130 to an SNS fluid supply. In various embodiments, each of the coupling elements 150, 170 are configured such that when a SNS fluid supply is not coupled thereto, the coupling element is closed and/or sealed from the external environment such that a nursing infant cannot cause air to be pulled into the SNS conduction system 130 via an uncoupled coupling element.

The SNS conduction system 130 is configured to fluidly couple each of the coupling elements 150, 170 to an outlet. In various embodiments, the outlet is located within the nipple portion 102 of the nipple shield 100. In various embodiments, the outlet is on the inside surface 106 of the nipple portion 102. In various embodiments, the outlet is on the outside surface 107 of the nipple portion. In various embodiments, the outlet is and/or is fluidly coupled to at least one hole 105 in the nipple portion 102.

For example, the coupling element 150 is configured to receive an SNS tube 160 therethrough. The SNS tube 160 may be connected to a syringe or drip bag containing formula or breast milk, for example. The microtubes 140 are food-grade microtubes that are configured to fluidly couple to the coupling element 150 and extend to an outlet. In various embodiments, the microtubes 140 are configured to fluidly connect an SNS tube 160 received in the coupling element 150 to an outlet. In various embodiments, the microtubes 140 extend to the at least one hole 105. For example, at least one of the holes 105 may be the outlet that is fluidly coupled to the coupling element 150 via the microtubes 140.

In various embodiments, the microtubes 140 comprise lateral microtubes 141 and circular microtubes 142. In various embodiments, lateral microtubes 141 extend from the tip of the nipple portion 102 to a distance down the nipple portion 102. In various embodiments, lateral microtubes 141 are fluidly connected by a circular microtube 142. In various embodiments, a circular microtube 142 is below the tip of the nipple portion 102. For example, the circular microtube 142 may be disposed at and/or adjacent the inner rim 103. In various embodiments, a microtube 140 fluidly connects a circular microtube 142 to the one or more coupling elements 150, 170.

In various embodiments, the SNS conduction system comprises two coupling elements 150 and 170. The coupling element 150 is configured to receive an microtube 160 from a traditional SNS. The SNS tube 160 may be connected to a syringe or drip bag containing formula or breast milk, for example. In such embodiments, the SNS tube 160 received in the coupling element 150 may be connected to an outlet. In various embodiments, the SNS tube 160 connects to the hole 105.

In various embodiments, with further reference to FIG. 5, the coupling element 150 comprises a multi-membrane port 155. In the illustrated embodiment, the multi-membrane port 155 comprises membranes 151. In various embodiments, the multi-membrane port 155 comprises a first membrane 151a and a second membrane 151b. In various embodiments, the first membrane 151a comprises a first hole 152a and the second membrane 151b comprises a second hole 152b. When the use of SNS is desired, an SNS tube 160 may be inserted into the first hole 152a, inserted into the second hole 152b, and placed into fluid communication with the microtubes 140. In various embodiments, the first membrane 151a and the second membrane 151b overlap such that the first hole 152a is covered by the second membrane 151b and the second hole 152b is covered by the first membrane 151a such that when an SNS is not used, the membranes 151a, 151b form a seal and prevent the leakage of air during suction of an infant. In various embodiments, the first hole 152a and the second hole 152b are angled at 180 degrees.

In various embodiments, the multi-membrane port 155 comprises multiple membranes 151. For example, the multi-membrane port 155 may comprise two or more membranes 151. In various embodiments, the multi-membrane port 155 comprises one membrane 151. In such embodiments, the singular membrane 151 may comprise a hole such that when SNS is not used, the singular membrane 151 forms a seal and prevents the leakage of air during suction of an infant.

In various embodiments, the diameter of the multi-membrane port 155 is in a range of 1.4 to 2.0 mm (e.g., 1.7 mm in an example embodiment). In such embodiments, the port 155 could accommodate a 5Fr size infant feeding tube, for example. In various embodiments, the internal diameter of the microtubes 140 is in a range of 400 to 600 μm (e.g., 500 μm, in an example embodiment).

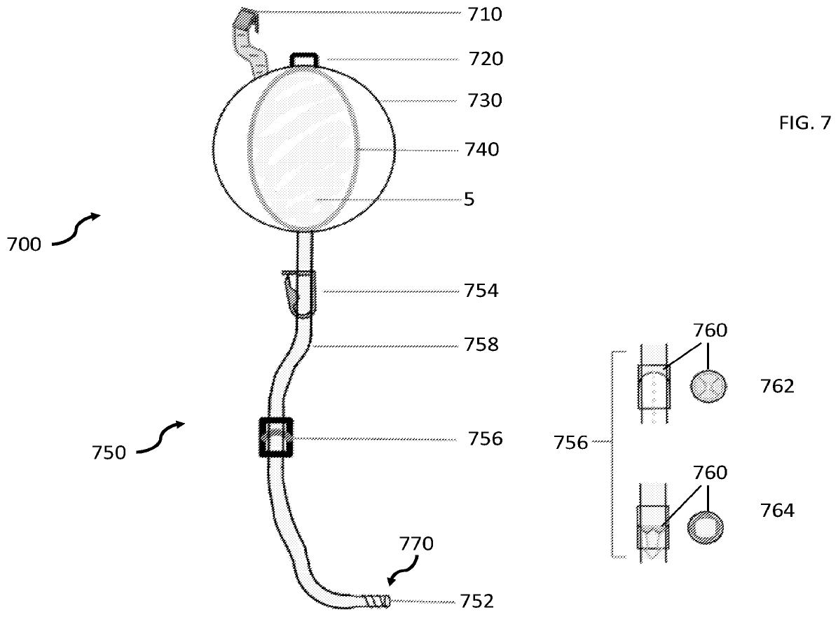

In an example embodiment, the coupling element 170 comprises a pairing port 172. The coupling element 170 is configured to fluidly couple the microtubes 140 to a fluid reservoir of an SNS system. For example, the coupling element 170 is configured to fluidly couple the microtubes 140 to an elastomeric reservoir 740 of an SNS pump 700 (see FIG. 7), in an example embodiment. The microtubes 140 are configured to fluidly couple to the coupling element 170 and extend to an outlet within the nipple portion 102, proximate one or more holes in the nipple portion 102, and/or the like.

In an example embodiment, the coupling element 170 comprises a shield pairing port 172 configured to engage, couple, and/or pair with a corresponding SNS pump pairing port 752. In an example embodiment, the shield pairing port 172 comprises an exterior rigid female Luer-port with inside thread, and one or more interior Luer-activated silicone valves. The shield pairing port 172 is configured such that when the shield pairing port 172 is not coupled to a pump pairing port 752, the inner silicone pair of valves come together, plug and/or seal the outlet of the female Luer-port, which does not allow air to enter the microtubes 140, as shown in the uncoupled/unpaired configuration 182. The shield pairing port 172 is further configured such that when a pump pairing port 752 (the male Luer-port) is inserted into the shield paring port 172, the inner silicone pair of valves are pushed apart and become separated, thus the shield pairing port 172 allows fluid communication between the microtubes 140 and a tube 758 of a dispensing assembly 750 of an SNS pump 700, as shown in the coupled/paired configuration 184.

In an example embodiment, the shield pairing port 172 is a female Luer-lock with inside threads. Thus, in the uncoupled/unpaired configuration 182, the shield pairing port 172 is fluidly sealed to the environment external to the SNS conduction system 130. In an example embodiment, the pump pairing port 752 is a male Luer-lock with outside threads. Thus, in the coupled/paired configuration 184, the SNS conduction system 130 is fluidly coupled to the dispensing assembly 750 of the SNS pump 700 such that fluid 5 dispensed from the elastomeric reservoir 740 is dispensed through the dispensing assembly 750 into the microtubes 140 of the nipple shield 100 and to the nursing infant (e.g., via the holes 105 in the nipple portion 102).

### Example SNS Pump

FIG. 7 provides a perspective view of an example embodiment of an SNS pump 700. The SNS pump 700 comprises an elastomeric reservoir 740 configured to store fluid 5 therein. The fluid 5 is dispensed from the elastomeric reservoir 740 via a dispensing assembly 750.

In an example embodiment, the elastomeric reservoir 740 is disposed within a pump housing 730. In various embodiments, the pump housing 730 is rigid. For example, the pump housing 730 may be configured to prevent the elastomeric reservoir 740 form being squeezed or otherwise mechanically compressed.

In various embodiments, the pump housing 730 and/or elastomeric reservoir comprises a filling port 720. In various embodiments, the filling port 720 includes a one way valve such that fluid 5 may be provided to the elastomeric reservoir 740 via the filling port 720.

In various embodiments, the pump housing 730 is coupled to a hanging mechanism 710. For example, the hanging mechanism 710 is a simple clip configured to anchor the pump from falling to the ground, anywhere within the length of the tubing, such as on mother's lap, shirt, covering blanket, or a pillow, no matter of height or gravity. For example, in various embodiments, the SNS pump is designed with a elastomeric reservoir configured to operate independent of gravity. In various embodiments, the hanging mechanism 710 comprises a cord, a hook, a hanging clip, and/or the like.

In various embodiments, the elastomeric reservoir 740 is resilient reservoir configured to stretch when fluid 5 is stored therein. The elastomeric reservoir 740 is configured to apply a force to the fluid 5 stored therein that, when enabled by the dispensing assembly 750, causes a flow of fluid 5 out of the elastomeric reservoir 740 through the dispensing assembly 750, independent of gravity. For example, the elastomeric reservoir 740 may use elastic constriction to push the fluid out of the elastomeric reservoir 740. For example, in various embodiments, the elastomeric reservoir 740 is configured to apply a compressive force to the fluid 5 stored and/or present therein. In various embodiments, the elastomeric reservoir 740 is configured to generate a consistent flow of fluid 5 that is independent of gravity and/or a user's position and that does not require a power source.

In an example embodiment, the elastomeric reservoir 740 comprises an elastomeric silicone material. In an example embodiment, the elastomeric reservoir 740 is configured such that, when fluid 5 is stored therein, the elastomeric reservoir 740 is generally spherical or ovoid in shape.

In various embodiments, fluid 5 is dispensed from the elastomeric reservoir 740 via a dispensing assembly 750. In various embodiments, the dispensing assembly 750 comprises a tube 758. In various embodiments, the tube 758 is a food grade micro-tube. For example, the diameter of the tube 758 is configured to enable a fluid flow that is not likely to overwhelm a nursing infant, in an example embodiment.

In various embodiments, the dispensing assembly 750 comprises a clamp 754 configured to selectively prevent the flow of fluid through the tube 758. For example, the clamp 754 may be used to prevent the flow of fluid 5 through the tube 758 while the SNS pump 700 is being set up for a nursing session (filing of the elastomeric reservoir 740 with fluid 5, positioning of the SNS pump 700, positioning of the nursing woman, positioning of the nursing infant, positioning of the dispensing assembly, and/or the like).

In various embodiments, the dispensing assembly 750 comprises a valve 756. In various embodiments, the valve 756 is a flow-adjusting valve disposed in the tube 758 and/or otherwise configured to at least partially control the flow of fluid 5 through the tube 758.

In various embodiments, the valve 756 comprises a membrane 760. In an example embodiment, the membrane 760 comprises a plurality of valve flaps (e.g., four valve flaps in the illustrated embodiment). In an example embodiment, the membrane is an upstream dome-shaped membrane. In an example embodiment, the upstream dome-shaped membrane presents a convex surface to fluid 5 traveling down the tube 758 from the elastomeric reservoir 740 toward the dispensing end 770, when no suction is applied to the dispensing end 770, as shown by the suction-free configuration 762. Thus, when no suction is applied to the dispensing end 770 of the tube 758, the valve flaps of the membrane 760 are closed such that at most only a small trickle of fluid 5 is able to pass through a small hole in the middle of the membrane.

When suction is applied to the dispensing end 770 (e.g., by a nursing infant), the negative downstream pressure causes the membrane 760 to assume the suction-present configuration 764. In the suction-present configuration 764, valve flaps of the membrane 760 are opened, which alleviates the flow restriction and allows a greater flow of fluid 5 (e.g., compared to the suction-free configuration 762) through the valve 756. In various embodiments, the valve is therefore configured to mimic the physiologic let-down reflect and encourage the nursing infant's suction behaviors.

In an example embodiment, the membrane 760 is a silicone membrane and/or comprises silicone.

In various embodiments, the SNS pump 750 is configured to be used independently (e.g., without a nipple shield). In such embodiments, the dispensing end 770 of the tube 758 may be the end of the tube 758.

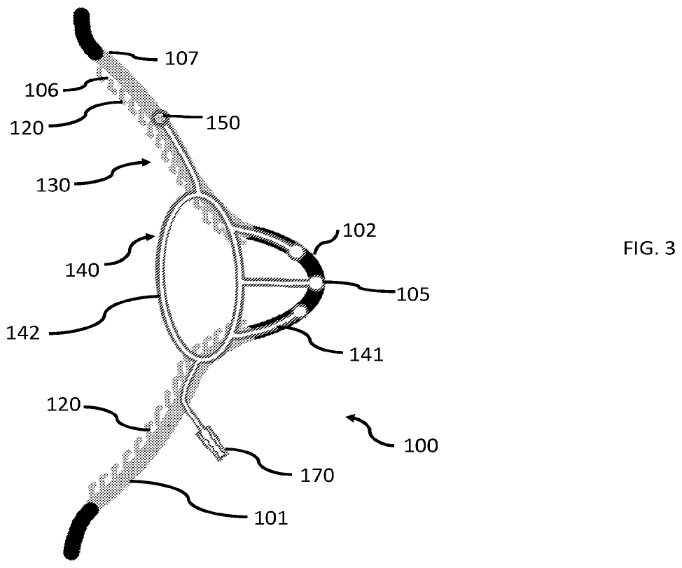

In various embodiments, the SNS pump 750 is configured to be used with a nipple shield (e.g., nipple shield 100 shown in FIG. 3) and the dispensing end 770 comprises the end of the tube 758 secured to a pump coupling port 752. In various embodiments, the pump coupling port 752 is configured to couple the tube 758 to an SNS conduction system of the nipple shield. In an example embodiment, the dispensing end 770 of the tube 758 is the end of the tube 758 and the dispensing assembly 750 is configured to be coupled to nipple shield 100 via at least one coupling element 150, 170 (e.g., multi-membrane port 155 or pump pairing port 172). In an example embodiment, the pump pairing port 752 is a male Luer-lock with outside threads. Thus, in the coupled/paired configuration 184, the SNS conduction system 130 is fluidly coupled to the dispensing assembly 750 of the SNS pump 700 such that fluid 5 dispensed from the elastomeric reservoir 740 is dispensed through the dispensing assembly 750 into the microtubes 140 of the nipple shield 100 and to the nursing infant (e.g., via the holes in the nipple portion 102).

In various embodiments, a microtube 140 fluidly connects a circular microtube 142 to the coupling element 170.

### Example Methods of Using at Least One Component of a Breastfeeding Assistance System

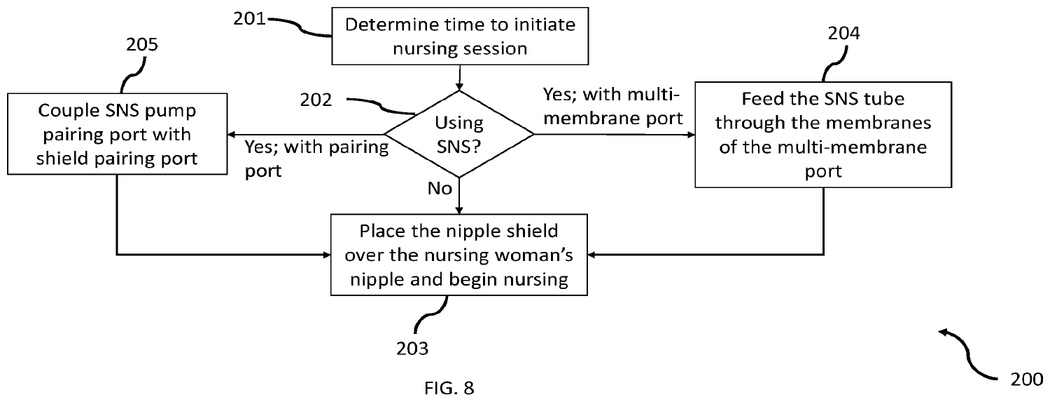

FIG. 8 provides a flowchart illustrating various processes, procedures, operations, and/or the like of an example method 200 for use of an example embodiment of the nipple shield 100. At step 201, a nursing woman decides to initiate a nursing session using a nipple shield 100. At step 202, the woman determines if she will use an SNS. If the answer to step 202 is no, the method proceeds to step 203. At step 203, the nipple shield 100 is placed on the woman's breast and over the nipple of the woman and the woman may begin the nursing session. In an example embodiment, placing of the nipple shield 100 on the woman's breast may cause the microstructures 120 to engage with the woman's skin so as to maintain the nipple shield 100 on the woman's breast via, for example, a weak van der Waals force.

Otherwise, if the answer to step 202 is yes and the SNS to be used is configured to couple to the nipple shield 100 via the multi-membrane port 155, the method proceeds to step 204. For example, when a nursing woman decides to use a traditional SNS or an SNS configured to dispense fluid via an SNS tube 160 (e.g., that does not include a pairing port), the process continues step 204. At step 204, an SNS tube 160 is fluidly coupled to the SNS conduction system 130 via the coupling element 150. For example, the SNS tube 160 connected to a syringe or drip bag containing formula, breast milk, or other supplemental nutrition fluid, for example, is fed through the multi-membrane port 155 of the nipple shield 100 to place the SNS tube 160 into fluid communication with the microtubes 140. The method then proceeds to step 203 where the nipple shield 100 is placed on the woman's breast and over the women's nipple and the nursing session is initiated.

When, at step 202, the answer is yes and the SNS to be used it configured to couple to the nipple shield via the pairing port 172, the method proceeds to step 205. For example, when a nursing woman decides to use a SNS pump 700 and/or other SNS configured to couple via a pairing port, the process continues to step 205. At step 205, a pump pairing port 752 is coupled and/or paired to the shield pairing port 172. For example, in the example embodiment where the pump pairing port 752 is a male Luer-lock with outside threads and the shield pairing port 172 is a female Luer-lock with inside threads, the respective threads of the pairing ports 752, 172 may be mated to couple and/or pair the pairing ports 752, 172 to one another and place the SNS conduction system 130 in fluid communication with the elastomeric reservoir 740 and/or other SNS fluid supply. The method then proceeds to step 203 where the nipple shield 100 is placed on the woman's breast and over the women's nipple and the nursing session is initiated.

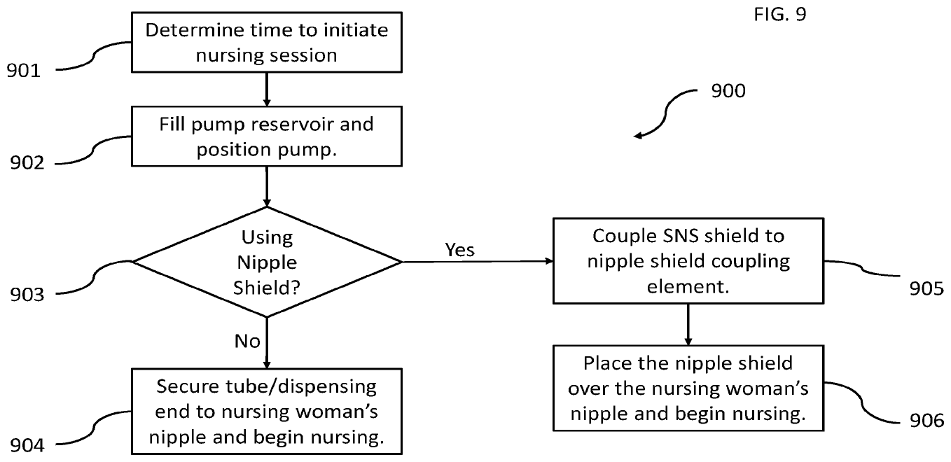

FIG. 9 provides a flowchart illustrating various processes, procedures, operations, and/or the like of an example method 900 for use of an example embodiment of the SNS pump 700. At step 901, a nursing woman decides to initiate a nursing session using an SNS pump 700. At step 902, the elastomeric reservoir 740 of the SNS pump 700 is filled with fluid (e.g., breast milk, formula, and/or the like) via the filling port 720. At step 903, the woman determines if she will use a nipple shield 100. If the answer to step 903 is no, the method proceeds to step 904. At step 904, the tube 758 and/or dispensing end 770 of the tube 758 is secured to the nursing woman's nipple such that fluid 5 dispensed via the dispensing end 770 is available at the woman's nipple for consumption by the nursing infant. The woman may then begin the nursing session.

If the answer to step 903 is yes, the method proceeds to step 905. At step 905, the SNS pump is coupled to the nipple shield 100. For example, the pump pairing port 752 may be coupled and/or paired to the shield pairing port 172 such that the elastomeric reservoir 740 is in fluid communication with the microtubes 140 of the nipple shield 100 . At step 906, the nipple shield 100 is placed on the woman's breast and over the nipple of the woman and the woman may begin the nursing session. In an example embodiment, placing of the nipple shield 100 on the woman's breast may cause the microstructures 120 disposed on the inside surface 106 of the nipple shield 100 to engage with the woman's skin so as to maintain the nipple shield 100 on the woman's breast via, for example, a weak van der Waals force.

### Conclusion

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments described and that modifications and other embodiments are intended to be included within the scope of the appended claims. Although specific terms are employed herein, they are used in a generic and descriptive sense only and not for purposes of limitation.

1-17. (canceled)

18. A nipple shield configured to adhere to a breast and allow for nursing of an infant, the nipple shield comprising:
an inner surface;
an outer surface; and
a base,
wherein the inner surface comprises micro-structures configured to adhere to a breast.

19. The nipple shield according to claim 18, further comprising a nipple portion, wherein the base is dome-shaped and extends from an outer rim to an inner rim and the nipple portion extends from the inner rim and the nipple portion is configured to receive a nipple therein.

20. The nipple shield according to claim 19, wherein the nipple portion comprises at least one small hole configured to allow for the passage of a fluid.

21. The nipple shield according to claim 20, wherein the at least one small hole is on the tip of the nipple portion.

22. The nipple shield according to claim 19, wherein the micro-structures generally cover the inner surface from the outer rim to the inner rim.

23. The nipple shield according to claim 22, wherein at least a portion of the outer rim of the nipple shield comprises no micro-structures.

24. The nipple shield according to claim 18, wherein the nipple shield comprises silicone.

25. The nipple shield according to claim 18, wherein the micro-structures are in close contact with the skin of the breast and form a seal therewith.

26. The nipple shield according to claim 18, wherein the micro-structures comprise angled fibers.

27. The nipple shield according to claim 26, wherein the micro-structures are directional and are radially aligned.

28. The nipple shield according to claim 18, wherein the micro-structures are configured to retain the breast within the nipple shield using a weak van der Waals interaction.

29. The nipple shield according to claim 18, wherein the outer surface is smooth.

30. The nipple shield according to claim 18, wherein the micro-structures are micro-scale pillars with angled mushroom tips.

31. The nipple shield according to claim 18, wherein the nipple shield comprises a supplementary nursing system (SNS) conduction system.

32. The nipple shield according to claim 31, wherein the SNS conduction system comprises at least one microtube disposed between the inner surface and the outer surface, the at least one microtube configured to fluidly couple a coupling element to at least one outlet.

33. A nipple shield configured to be used with a supplemental nursing system (SNS), the nipple shield comprising: (1) a base having (a) an inner surface, and (b) an outer surface, and (2) an SNS conduction system, said SNS conduction system comprising one or more coupling elements and one or more microtubes;
wherein:
each of said one or more coupling elements is configured to fluidly couple a dispensing assembly of an SNS pump to the microtubes;
said microtubes are disposed between the inner surface and outer surface; and
at least one of said microtubes is fluidly coupled to the coupling element and extends from the coupling element to an outlet.

34. The nipple shield of claim 33, wherein the one or more coupling elements comprise a female Luer-lock having inside threads and configured to receive a male Luer-lock having outside threads at least partially therein.

35. The nipple shield of claim 33, wherein the one or more coupling elements comprise a multi-membrane port comprising at least two at least partially overlapping membranes, each of the at least two at least partially overlapping membranes comprising a respective hole therethrough such that a first hole through a first membrane misaligned with respect to a second hole through a second membrane.

36. The nipple shield of claim 33, wherein the outlet is disposed in a nipple portion of the nipple shield.

37. The nipple shield of claim 33, wherein at least a portion of the inner surface comprises a plurality of micro-structures configured to adhere to a breast.

38-52. (canceled)
